(19) United States
(12) Patent Application Publication
(10) Pub. No.: US 2026/0259113 A1
(43) Pub. Date: Sep. 3, 2026

(54) INTERMITTENT IN-SITU CURRENT-CARRYING FRICTION TESTING DEVICE

(71) Applicant: Jilin University, Changchun (CN)

(72) Inventors: Zhichao Ma, Changchun (CN); Jiakai Li, Shizuishan (CN); Yangzhi Zeng, Ganzhou (CN); Chaofan Li, Jiaohe (CN); Jingshi Dong, Beijing (CN); Faxin Li, Changchun (CN); Hongwei Zhao, Changchun (CN); Luquan Ren, Changchun (CN)

(21) Appl. No.: 19/656,874

(22) Filed: Apr. 23, 2026

(30) Foreign Application Priority Data
Feb. 5, 2026 (CN) 202610164923.3

(51) Int. Cl. G01M 99/00; F41B 6/00

(52) U.S. Cl. CPC G01M 99/005; F41B 6/006

(57) ABSTRACT

The present application provides an intermittent in-situ current-carrying friction testing device, and belongs to the technical field of physical property testing. The testing device includes a base, a double-disc friction mechanism is installed on a top of the base, the double-disc friction mechanism is configured for simulating current-carrying friction between an armature and a rail during shell launching, a third mounting seat is installed on a top of a second mounting seat, a high-speed camera is fixedly connected to a middle position of a top of the third mounting seat, a support frame is fixedly connected to one side of the top of the third mounting seat, and an infrared thermal imager and an acoustic emission sensor are installed on the support frame. According to the present application, stable constant-current input is performed on the entire device, and the testing device can perform a stable experiment for a long time.

### CROSS-REFERENCE TO RELATED APPLICATIONS

This application claims priority to Chinese Patent Application No. CN202610164923.3, filed on February 05, 2026, which is hereby incorporated by reference in its entirety.

### TECHNICAL FIELD

The present application relates to the technical field of physical property testing, and in particular, to an intermittent in-situ current-carrying friction testing device.

### BACKGROUND

In the construction of an equivalent test for a linear electromagnetic rail launch system, the electromagnetic rail launch system accelerates and launches a shell (armature) in a barrel (rail). However, due to an electromagnetic-force driving mode of the this system, a material needs to bear greater electrical impact and force impact at an initial acceleration stage than at a latter half stage, and arc ablation is highly likely to be formed at a starting point portion. At the latter half portion, in addition to a forward driving force, electromagnetic force enables the shell to bear a lateral force, promotes close contact between the shell and the rail, and forms a stable friction force. The occurrence of arcs is stably reduced, and a stable current-carrying friction form is more reflected.

Since the electromagnetic rail launch device adopts a linear launch mode, the following problems exist:

After shell launching, before a next experiment is performed, it is ensured that the shell needs to be reloaded in the rail (safety issues: residual capacitor charge needs to be ensured to be completely discharged, a thyristor switch state needs to be ensured to be normal, and the like), resulting in a complex process and time delay.

Due to severe current-carrying friction, metallic aluminum is melt-coated on a rail surface. The driving only by electromagnetic force easily causes shell launch jamming. Therefore, the rail further needs to be cleaned.

The device of the linear electromagnetic rail launch system imposes requirements on in-situ testing. For a relatively large-scale shell, high-speed acquisition equipment such as a high-speed camera and infrared thermal imaging faces a condition that an observation region exceeds a maximum frame range.

Therefore, the present application provides an intermittent in-situ current-carrying friction testing device to meet requirements.

### SUMMARY

Aiming at the technical problem, the present application provides an intermittent in-situ current-carrying friction testing device, where a double-disc friction mechanism is arranged, the contact between an aluminum alloy disc and a copper alloy disc is used as a medium of a conductive loop, and direct-current voltage is loaded on surfaces of the aluminum alloy disc and the copper alloy disc by means of a brush rod, so that stable constant-current input is performed on the entire device; since the aluminum alloy disc and the copper alloy disc are both in a relatively rotating state, the testing device can perform a stable experiment for a long time; and through the above arrangement, a problem can be solved that, after shell launching by a current-stage testing instrument and before a next experiment is performed, a shell needs to be ensured to be reloaded in a rail, resulting in a complex process and time delay.

To solve the above technical problem, the present application provides the following technical solutions:

An intermittent in-situ current-carrying friction testing device includes a base, where a first mounting seat is fixedly connected to a top of the base, a first movable platform is slidably connected to a top of the first mounting seat, a first adjustment mechanism is installed between the first mounting seat and the first movable platform, the first adjustment mechanism is configured for relative position adjustment between the first mounting seat and the first movable platform, a double-disc friction mechanism is installed on the top of the base, the double-disc friction mechanism is configured to simulate current-carrying friction between an armature and a rail during shell launching, the double-disc friction mechanism is connected to each of the first movable platform and the base, a second mounting seat is fixedly connected to the top of the base, a third mounting seat is installed on a top of the second mounting seat, a second adjustment mechanism is installed between the second mounting seat and the third mounting seat, the second adjustment mechanism is configured for relative position adjustment between the second mounting seat and the third mounting seat, a high-speed camera is fixedly connected to a middle position of a top of the third mounting seat, a support frame is fixedly connected to one side of the top of the third mounting seat, and an infrared thermal imager and an acoustic emission sensor are installed on the support frame.

Optionally, the first adjustment mechanism includes first linear guide rails symmetrically installed on two sides of the top of the first mounting seat, a first bearing seat is fixedly connected to a middle position of the top of the first mounting seat, a first driving screw rod is rotatably connected in the first bearing seat, a first hand wheel is fixedly connected to one end of the first driving screw rod, a first screw rod nut is in threaded connection with an outer wall of the first driving screw rod, a top of the first screw rod nut and a bottom of the first movable platform are fixed through screws, and the bottom of the first movable platform and tops of the first linear guide rails are fixed through screws.

Optionally, the double-disc friction mechanism includes a first motor and a first machine cover fixedly connected to the top of the first movable platform, a first driving shaft is rotatably connected in the first machine cover, an aluminum alloy disc is fixedly connected to a top end of the first driving shaft, the double-disc friction mechanism further includes a second machine cover and a second motor fixedly connected to the top of the base, a second driving shaft is rotatably connected in the second machine cover, a copper alloy disc is fixedly connected to a top end of the second driving shaft, a recess is formed in an outer circumference of the aluminum alloy disc, a protrusion having a profile consistent with a contour of the recess on the outer circumference of the aluminum alloy disc is fixedly connected to an outer circumference of the copper alloy disc, and an intermittent groove is formed in the aluminum alloy disc.

Optionally, a first bevel gear set is installed in the first machine cover, the first bevel gear set is composed of two bevel gears engaged with each other, where one bevel gear on the first bevel gear set is fixed with a bottom end of the first driving shaft, and the other bevel gear is fixed with an output end of the first motor.

Optionally, a driving gear set and a second bevel gear set are installed in the second machine cover, the driving gear set is composed of two gears engaged with each other, the second bevel gear set is composed of two bevel gears engaged with each other, where one gear on the driving gear set and one bevel gear on the second bevel gear set are fixed on a same bearing, the bearing is rotatably connected to the second machine cover, the other gear on the driving gear set is fixed with an output end of the second motor, and the other bevel gear on the second bevel gear set is fixed with a bottom end of the second driving shaft.

Optionally, a U-shaped frame is fixedly connected to the top of the first movable platform, brush cylinders are fixedly connected to the U-shaped frame and a top of the second machine cover, a handle and a brush rod are sequentially inserted on each brush cylinder from top to bottom, a bottom end of the handle is attached to a top end of the brush rod, a first spring is fixedly connected in the brush cylinder, one end of the first spring is fixed with the top end of the brush rod, and the other end of the first spring is fixed with an inner wall of the brush cylinder.

Optionally, two adjusters are fixedly connected to an outer wall of the support frame, a first adjustment rod is inserted on one adjuster, a second adjustment rod is inserted on the other adjuster, a first mounting frame is fixedly connected to an outer wall of the first adjustment rod, the infrared thermal imager and the first adjustment rod are fixed through the first mounting frame, a second mounting frame is fixedly connected to an outer wall of the second adjustment rod, the acoustic emission sensor and the second adjustment rod are fixed through the second mounting frame, the acoustic emission sensor is located at a circle center position of the copper alloy disc, a conductive slip ring is sleeved on an outer wall of the acoustic emission sensor, the conductive slip ring is fixed with a top outer wall of the copper alloy disc through screws, a second spring is fixedly connected to a bottom of the conductive slip ring, a top end of the second spring is attached to the bottom of the conductive slip ring, and a bottom end of the second spring is fixed with a top end of the acoustic emission sensor.

Optionally, the second adjustment mechanism includes second linear guide rails and first fixing seats symmetrically installed on two sides of the top of the second mounting seat, fifth bearing seats are fixedly connected to tops of the second linear guide rails and the first fixing seats, a connecting plate is fixedly connected to the fifth bearing seat located on the top of the second linear guide rail, a second bearing seat is fixedly connected to the top of the second mounting seat, a second driving screw rod is rotatably connected in the second bearing seat, a second hand wheel is fixedly connected to one end of the second driving screw rod, a second screw rod nut is in threaded connection with an outer wall of the second driving screw rod, and a top of the second screw rod nut is fixed with a bottom of the connecting plate through screws.

Optionally, the second adjustment mechanism further includes a lifting platform installed on the top of the second mounting seat, fifth linear guide rails and second fixing seats are fixedly connected to two sides of a bottom of the lifting platform, the fifth bearing seats are fixedly connected to bottoms of the fifth linear guide rails and the second fixing seats, the fifth linear guide rails and the first fixing seats are fixed through scissor arms, the second linear guide rails and the second fixing seats are fixed through scissor arms, a total of four scissor arms are provided, every two scissor arms are divided into one group to form two groups, and each group of the scissor arms is rotatably connected together through a rotating shaft.

Optionally, the second adjustment mechanism further includes two third linear guide rails and two fourth linear guide rails symmetrically installed on the top of the lifting platform, where the two third linear guide rails and the two fourth linear guide rails are oppositely installed on the lifting platform, a third bearing seat is fixedly connected to a top of the third linear guide rail, a third driving screw rod is rotatably connected in the third bearing seat, a third hand wheel is fixedly connected to one end of the third driving screw rod, a fourth bearing seat is fixedly connected to a top of the fourth linear guide rail, a fourth driving screw rod is rotatably connected in the fourth bearing seat, a fourth hand wheel is fixedly connected to one end of the fourth driving screw rod, a height of the fourth driving screw rod is greater than a height of the third driving screw rod, the fourth driving screw rod is horizontally relatively perpendicular to the third driving screw rod, a third screw rod nut is simultaneously in threaded connection with the third driving screw rod and the fourth driving screw rod, a second movable platform is fixedly connected to a top of the third screw rod nut, and the second movable platform is fixedly connected to a bottom of the third mounting seat.

Compared with the prior art, the present application at least has the following beneficial effects:

In the above technical solution, the double-disc friction mechanism is arranged, the contact between the aluminum alloy disc and the copper alloy disc is used as a medium of a conductive loop, and direct-current voltage is loaded on surfaces of the aluminum alloy disc and the copper alloy disc by means of the brush rod, so that stable constant-current input is performed on the entire device. Since the aluminum alloy disc and the copper alloy disc are both in a relatively rotating state, the testing device can perform a stable experiment for a long time, thereby solving a problem that, after shell launching by a current-stage testing instrument and before a next experiment is performed, a shell needs to be ensured to be reloaded in a rail, resulting in a complex process and time delay.

In this technical solution, since the aluminum alloy disc and the copper alloy disc respectively use aluminum alloy commonly used for manufacturing shells and copper alloy commonly used for manufacturing launch rails, the physical characteristics of a test object are better matched. In addition, the contour of the recess on the outer circumference of the aluminum alloy disc is adapted to the contour of the protrusion on the outer circumference of the copper alloy disc. Such an arrangement enables outer walls of the aluminum alloy disc and the copper alloy disc to be respectively designed as forms of an outer wall of a shell and an inner wall of a rail, and equivalent shell launching is achieved by relative sliding of disc-shaped samples, thereby improving simulation performance and testing precision of the instrument. In addition, after a surface of the aluminum alloy disc is melt-coated on a surface of the copper alloy disc during a current-carrying friction process, the aluminum alloy disc and the copper alloy disc are independently driven by the first motor and the second motor respectively, therefore a user only needs to focus on states of acting surfaces of the aluminum alloy disc and the copper alloy disc without concern about a jamming problem. Further, by forming the intermittent groove in the aluminum alloy disc, a friction interval exists at a formed position of the intermittent groove during mutual rotational friction between the aluminum alloy disc and the copper alloy disc, thereby achieving an effect of intermittent friction between the aluminum alloy disc and the copper alloy disc.

By arranging the second adjustment mechanism, a user can enable the third mounting seat to use a center of the third mounting seat as a coordinate origin and adjust a position and a height of the third mounting seat in three different directions of X, Y, and Z, thereby enabling the high-speed camera, the infrared thermal imager, and the acoustic emission sensor only to focus on a sample contact interface, and stable in-situ testing can be achieved. In addition, the intermittent contact mode provided by the present application can further stably control arc generation at a contact starting point position, and has higher efficiency.

### BRIEF DESCRIPTION OF DRAWINGS

The accompanying drawings, which are incorporated in and constitute a part of the specification, illustrate embodiments of the present application, and further serve to explain principles of the present application together with the specification, and enable those skilled in the related art to make and use the present application.

FIG. 1 is a schematic diagram of a structure of an intermittent in-situ current-carrying friction testing device at a first viewing angle;

FIG. 2 is a schematic diagram of a structure of an intermittent in-situ current-carrying friction testing device at a second viewing angle;

FIG. 3 is a schematic diagram of an enlarged perspective structure of a double-disc friction mechanism and a first adjustment mechanism;

FIG. 4 is a schematic diagram of an enlarged perspective structure of a first adjustment mechanism and a first machine cover;

FIG. 5 is a schematic diagram of a cross-sectional perspective structure of a first adjustment mechanism;

FIG. 6 is a schematic diagram of an enlarged perspective structure of a first adjustment mechanism;

FIG. 7 is a schematic diagram of a cross-sectional perspective structure of a U-shaped frame, a brush cylinder, and an aluminum alloy disc;

FIG. 8 is a schematic diagram of an enlarged perspective structure of portion A in FIG. 7;

FIG. 9 is a schematic diagram of an enlarged perspective structure of a second machine cover, a second motor, and a copper alloy disc;

FIG. 10 is a schematic diagram of an enlarged perspective structure of a second motor, a driving gear set, a second bevel gear set, a second driving shaft, and a copper alloy disc;

FIG. 11 is a schematic diagram of a perspective structure of a second adjustment mechanism at a first viewing angle;

FIG. 12 is a schematic diagram of a perspective structure of a second adjustment mechanism at a second viewing angle;

FIG. 13 is a schematic diagram of an enlarged perspective structure of a second mounting seat and a connecting plate;

FIG. 14 is a schematic diagram of an enlarged perspective structure of a second linear guide rail and a fifth bearing seat;

FIG. 15 is a schematic diagram of an enlarged perspective structure of a second linear guide rail, a first fixing seat, a third linear guide rail, a second fixing seat, and a scissor arm;

FIG. 16 is a schematic diagram of an exploded perspective structure of a scissor arm and a rotating shaft;

FIG. 17 is a schematic diagram of an enlarged perspective structure of a lifting platform and a second movable platform;

FIG. 18 is a schematic diagram of an enlarged perspective structure of a lifting platform, a third mounting seat, a high-speed camera, and a support frame;

FIG. 19 is a schematic diagram of an enlarged perspective structure of a third mounting seat, a high-speed camera, and a support frame;

FIG. 20 is a schematic diagram of an enlarged perspective structure of a support frame, an infrared thermal imager, and an acoustic emission sensor;

FIG. 21 is a schematic diagram of an enlarged perspective structure of an aluminum alloy disc and a copper alloy disc at a first viewing angle; and

FIG. 22 is a schematic diagram of an enlarged perspective structure of an aluminum alloy disc and a copper alloy disc at a second viewing angle.

Reference numerals:

1. base; 2. first mounting seat; 3. first linear guide rail; 4. first bearing seat; 5. first driving screw rod; 6. first hand wheel; 7. first screw rod nut; 8. first movable platform; 9. first motor; 10. first driving shaft; 11. first bevel gear set; 12. aluminum alloy disc; 13. first machine cover; 14. U-shaped frame; 15. brush cylinder; 16. handle; 17. brush rod; 18. first spring; 19. second machine cover; 20. second motor; 21. driving gear set; 22. second bevel gear set; 23. second driving shaft; 24. copper alloy disc; 25. second mounting seat; 26. second linear guide rail; 27. first fixing seat; 28. fifth bearing seat; 29. second bearing seat; 30. second driving screw rod; 31. second hand wheel; 32. second screw rod nut; 33. connecting plate; 34. lifting platform; 35. fifth linear guide rail; 36. second fixing seat; 37. scissor arm; 38. rotating shaft; 39. third linear guide rail; 40. third bearing seat; 41. third driving screw rod; 42. third hand wheel; 43. fourth linear guide rail; 44. fourth bearing seat; 45. fourth driving screw rod; 46. fourth hand wheel; 47. third screw rod nut; 48. second movable platform; 49. third mounting seat; 50. high-speed camera; 51. support frame; 52. adjuster; 53. first adjustment rod; 54. first mounting frame; 55. infrared thermal imager; 56. second adjustment rod; 57. second mounting frame; 58. acoustic emission sensor; 59. conductive slip ring; 60. second spring; 61. protrusion; 62. recess; 63. intermittent groove; 64. first adjustment mechanism; 65. double-disc friction mechanism; and 66. second adjustment mechanism.

As shown in the drawings, to clearly realize structures of embodiments of the present application, specific structures and devices are illustrated in the drawings. However, such illustration is only for schematic purposes and is not intended to limit the present application to the specific structures, devices, and environments. According to specific needs, those of ordinary skill in the art may adjust or modify such devices and environments.

### DESCRIPTION OF EMBODIMENTS

An intermittent in-situ current-carrying friction testing device provided by the present application is described in detail below in conjunction with the accompanying drawings and specific embodiments. Meanwhile, an explanation is made herein that, to make the embodiments more detailed, the following embodiments are optimal embodiments and preferred embodiments. For some known technologies, those skilled in the art may also implement by adopting other alternative manners. In addition, the drawing part is only for more specifically describing the embodiments, and is not intended to specifically limit the present application.

It should be noted that references in the specification to "one embodiment", "an embodiment", "an exemplary embodiment", "some embodiments", and the like indicate that the described embodiment may include a particular feature, structure, or characteristic, but each embodiment does not necessarily include the particular feature, structure, or characteristic. In addition, when a particular feature, structure, or characteristic is described in conjunction with an embodiment, the implementation of the feature, structure, or characteristic in conjunction with other embodiments, whether or not explicitly described, falls within knowledge of those skilled in the related art.

Generally, terms can be understood at least in part from usage in context. For example, depending at least in part on context, the term "one or more" used herein may be used for describing any feature, structure, or characteristic in a singular sense, or may be used for describing a combination of features, structures, or characteristics in a plural sense. In addition, the term "based on" can be understood as not necessarily intended to convey a set of exclusive factors, but alternatively, depending at least in part on context, can allow presence of other factors not necessarily expressly described.

It can be understood that meanings of "on", "over", and "above" in the present application should be interpreted in a broadest manner, so that "on" not only means "directly on" something, but also includes being on something with an intermediate feature or layer therebetween, and "over" or "above" not only means being "over" or "above" something, but also can include being "over" or "above" something without an intermediate feature or layer therebetween.

In addition, spatially related terms such as "below", "under", "lower portion", "above", and "upper portion" may be used herein for convenience of description to describe a relationship of one element or feature relative to another element or feature, as shown in the drawings. The spatially related terms are intended to encompass different orientations in use or operation of a device in addition to orientations depicted in the drawings. The device may be oriented in other manners, and the spatially related descriptive terms used herein may be correspondingly interpreted in a similar manner.

Embodiment 1:

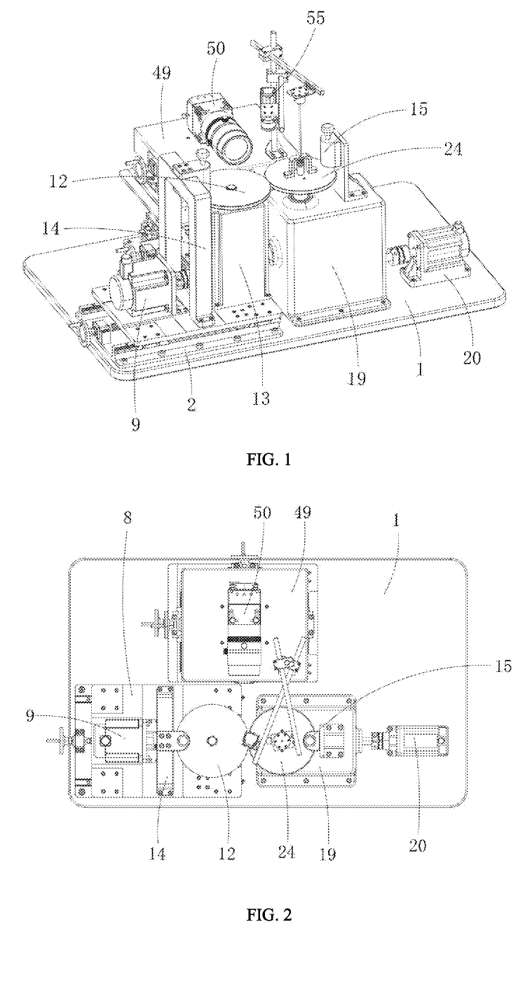

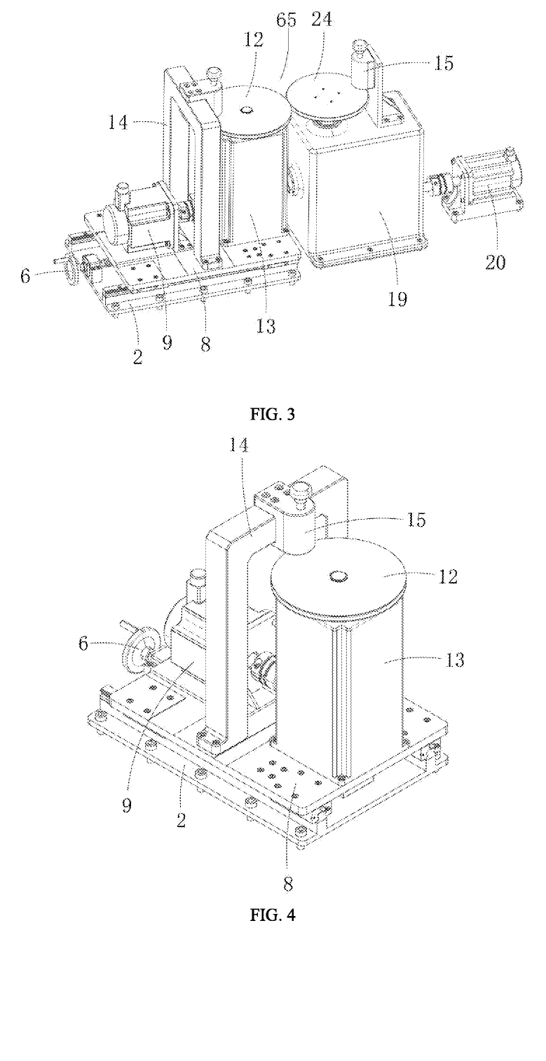

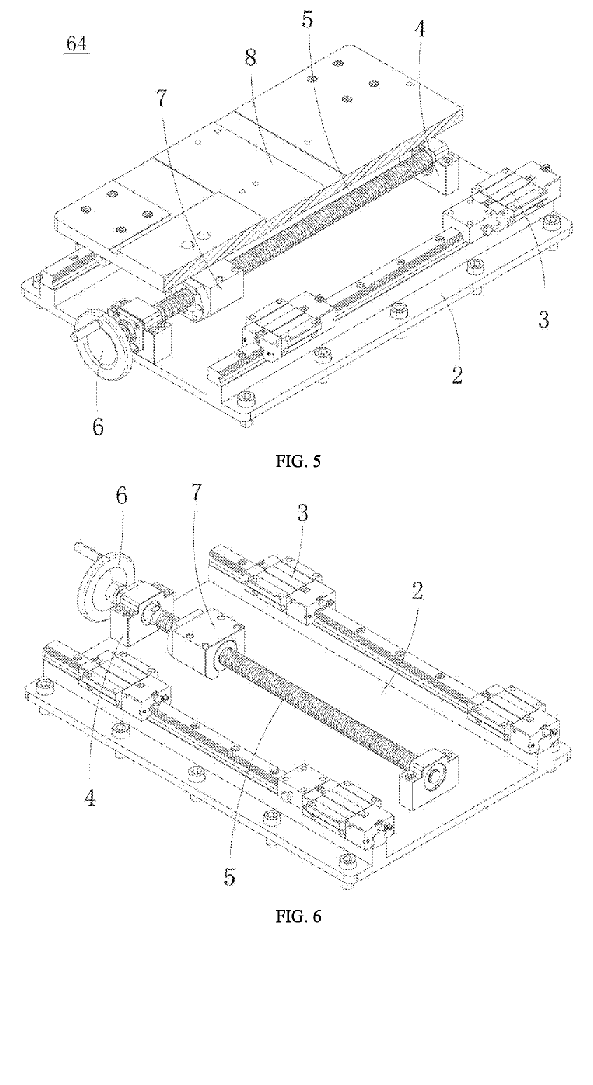

As shown in FIG. 1 to FIG. 6, an embodiment of the present application provides an intermittent in-situ current-carrying friction testing device, which includes a base 1, where a first mounting seat 2 is fixedly connected to a top of the base 1, a first movable platform 8 is slidably connected to a top of the first mounting seat 2, a first adjustment mechanism is installed between the first mounting seat 2 and the first movable platform 8, the first adjustment mechanism is configured for relative position adjustment between the first mounting seat 2 and the first movable platform 8, the first adjustment mechanism includes first linear guide rails 3 symmetrically installed on two sides of the top of the first mounting seat 2, a first bearing seat 4 is fixedly connected to a middle position of the top of the first mounting seat 2, a first driving screw rod 5 is rotatably connected in the first bearing seat 4, a first hand wheel 6 is fixedly connected to one end of the first driving screw rod 5, a first screw rod nut 7 is in threaded connection with an outer wall of the first driving screw rod 5, a top of the first screw rod nut 7 and a bottom of the first movable platform 8 are fixed through screws, and the bottom of the first movable platform 8 and tops of the first linear guide rails 3 are fixed through screws.

With the arrangement of the above structure, when a user rotates the first hand wheel 6, the first screw rod nut 7 synchronously drives the first movable platform 8 to move along a traveling direction of the first linear guide rail 3 under threaded driving action between the first driving screw rod 5 and the first screw rod nut 7. The user can change a rotating direction of the first hand wheel 6 to switch a moving direction of the first movable platform 8 on the first linear guide rail 3, and can adjust a moving distance of the first movable platform 8 by changing a number of rotation turns of the first hand wheel 6.

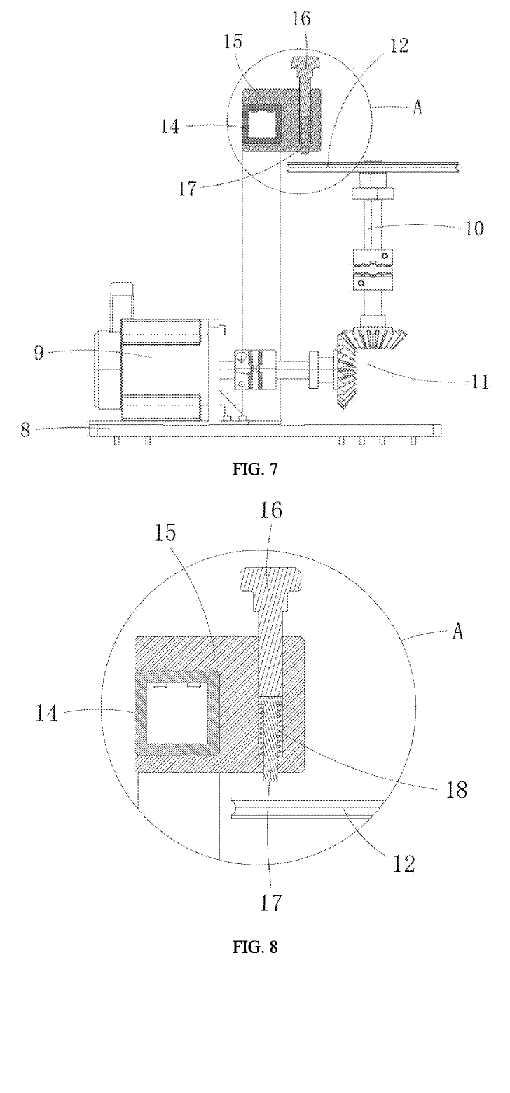

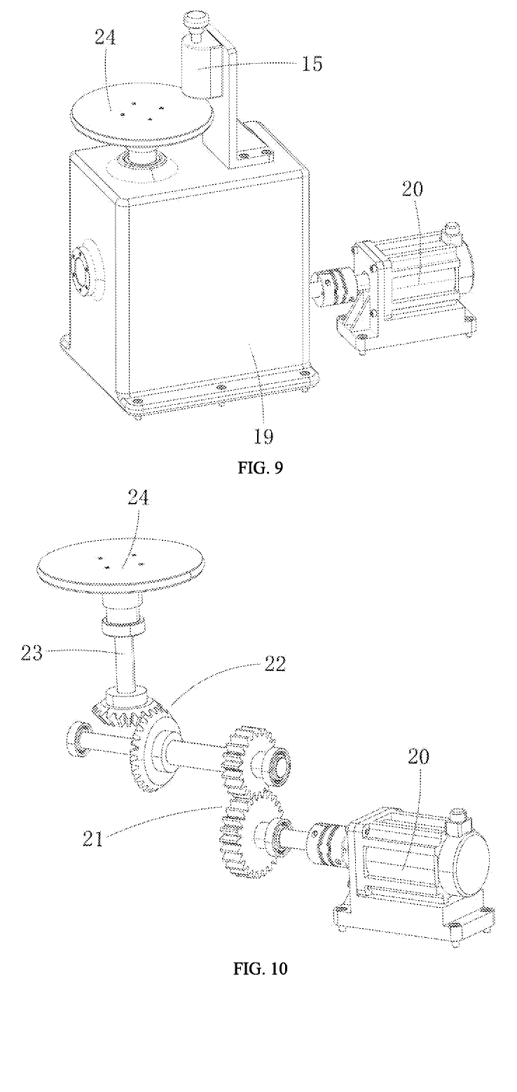

As an implementation in this embodiment, as shown in FIG. 1 to FIG. 4 and FIG. 7 to FIG. 10, a double-disc friction mechanism is installed on the top of the base 1, the double-disc friction mechanism is configured to simulate current-carrying friction between an armature and a rail during shell launching, the double-disc friction mechanism is connected to each of the first movable platform 8 and the base 1, the double-disc friction mechanism includes a first motor 9 and a first machine cover 13 fixedly connected to the top of the first movable platform 8, a first driving shaft 10 is rotatably connected in the first machine cover 13, an aluminum alloy disc 12 is fixedly connected to a top end of the first driving shaft 10, a first bevel gear set 11 is installed in the first machine cover 13, the first bevel gear set 11 is composed of two bevel gears engaged with each other, where one bevel gear on the first bevel gear set 11 is fixed with a bottom end of the first driving shaft 10, and the other bevel gear is fixed with an output end of the first motor 9.

According to the above structure, after the first motor 9 is started, the first driving shaft 10 rotates under driving action of the first bevel gear set 11, and the aluminum alloy disc 12 is driven to rotate on the top of the first machine cover 13 during rotation of the first driving shaft 10. In this technical solution, a driving principle of cooperation among the first bevel gear set 11, the first motor 9, and the first driving shaft 10 is disclosed in the prior art. Details are not described herein again.

In this embodiment, as shown in FIG. 1 to FIG. 10, the double-disc friction mechanism further includes a second machine cover 19 and a second motor 20 fixedly connected to the top of the base 1, a second driving shaft 23 is rotatably connected in the second machine cover 19, a copper alloy disc 24 is fixedly connected to a top end of the second driving shaft 23, a driving gear set 21 and a second bevel gear set 22 are installed in the second machine cover 19, the driving gear set 21 is composed of two gears engaged with each other, the second bevel gear set 22 is composed of two bevel gears engaged with each other, where one gear on the driving gear set 21 and one bevel gear on the second bevel gear set 22 are fixed on a same bearing, and the bearing is rotatably connected to the second machine cover 19, the other gear on the driving gear set 21 is fixed with an output end of the second motor 20, and the other bevel gear on the second bevel gear set 22 is fixed with a bottom end of the second driving shaft 23.

According to the above structure, after the second motor 20 is started, the second driving shaft 23 rotates under cooperative driving action of the driving gear set 21 and the second bevel gear set 22, and the copper alloy disc 24 is driven to rotate on the top of the second machine cover 19 during rotation of the second driving shaft 23. In this technical solution, a driving principle of cooperation among the driving gear set 21, the second bevel gear set 22, the second motor 20, and the second driving shaft 23 is disclosed in the prior art. Details are not described herein again.

Further, in this technical solution, the double-disc friction mechanism is arranged to simulate current-carrying friction between an armature and a rail during shell launching. Compared with pin-disc and ring-block structures, this double-disc structure is more innovative. The aluminum alloy disc 12 and the copper alloy disc 24 are respectively driven by the first motor 9 and the second motor 20 to rotate in opposite directions, thereby greatly improving a relative sliding speed between the aluminum alloy disc 12 and the copper alloy disc 24. In addition, the aluminum alloy disc 12 and the copper alloy disc 24 respectively use aluminum alloy commonly used for manufacturing shells and copper alloy commonly used for manufacturing launch rails, which are more consistent with physical characteristics of a test object, so that results tested by the testing device are more accurate.

Furthermore, since the first motor 9 and the first machine cover 13 are both installed on the first adjustment mechanism, a user can change a relative spacing between the aluminum alloy disc 12 and the copper alloy disc 24 by rotating the first hand wheel 6. During a test variable process, a friction speed can be adjusted not only by changing rotational speeds of the first motor 9 and the second motor 20, but also by changing radii of the aluminum alloy disc 12 and the copper alloy disc 24. Since a center distance between the aluminum alloy disc 12 and the copper alloy disc 24 can be adjusted and fixed by the first adjustment mechanism, the testing device can change a distance between transmission shafts of the aluminum alloy disc 12 and the copper alloy disc 24. After a user changes a size of the aluminum alloy disc 12 or the copper alloy disc 24, a spacing between the aluminum alloy disc 12 and the copper alloy disc 24 can be adjusted by manually rotating the first hand wheel 6, so that outer walls of the aluminum alloy disc 12 and the copper alloy disc 24 are always kept in contact friction, thereby increasing an application range of the instrument.

In this embodiment, as shown in FIG. 1 to FIG. 10, a U-shaped frame 14 is fixedly connected to the top of the first movable platform 8, brush cylinders 15 are fixedly connected to the U-shaped frame 14 and the top of the second machine cover 19, a handle 16 and a brush rod 17 are sequentially inserted on each brush cylinder 15 from top to bottom, a bottom end of the handle 16 is attached to a top end of the brush rod 17, a first spring 18 is fixedly connected in the brush cylinder 15, one end of the first spring 18 is fixed with the top end of the brush rod 17, and the other end of the first spring 18 is fixed with an inner wall of the brush cylinder 15.

In this technical solution, the brush rod 17 is made of copper, the brush cylinder 15 is provided with a groove body for insertion and limiting of the handle 16 and the brush rod 17, a bottom of the handle 16 is in threaded connection in the groove body on the brush cylinder 15, and the groove body of the brush cylinder 15 is provided with a small hole for insertion of an electric wire, where the small hole is located at a connection position of the handle 16 and the brush rod 17. When the handle 16 is not rotated and pressed downward, the brush rod 17 does not contact the aluminum alloy disc 12 or the copper alloy disc 24 under elastic force action of the first spring 18. When current needs to be loaded to the aluminum alloy disc 12 and the copper alloy disc 24, the brush rod 17 is pulled downward, then the electric wire is inserted into the small hole at the connection position of the handle 16 and the brush rod 17, and finally the electric wire is clamped by screwing the handle 16 under threaded cooperation action, while the bottom of the handle 16 presses the brush rod 17, so that a bottom of the brush rod 17 contacts upper surfaces of the aluminum alloy disc 12 and the copper alloy disc 24. When the electric wire is energized, current can be loaded to the aluminum alloy disc 12 and the copper alloy disc 24 by means of the brush rod 17.

Further, a magnitude of current on the surfaces of the aluminum alloy disc 12 and the copper alloy disc 24 depends on an energizing magnitude of the electric wire. The direct-current voltage is loaded to the surfaces of the aluminum alloy disc 12 and the copper alloy disc 24 by means of the brush rod 17, so that current during sample friction is generated on the surfaces of the aluminum alloy disc 12 and the copper alloy disc 24. A power supply voltage of the electric wire may be loaded by a fully charged large-capacity capacitor to simulate one-time shell launching, similar to designing a miniature electromagnetic rail launch process. The electric wire may also be powered by a high-voltage constant-current source to continuously and uninterruptedly simulate a high-speed high-current current-carrying friction process. With such an arrangement, the testing accuracy of the testing device is further improved.

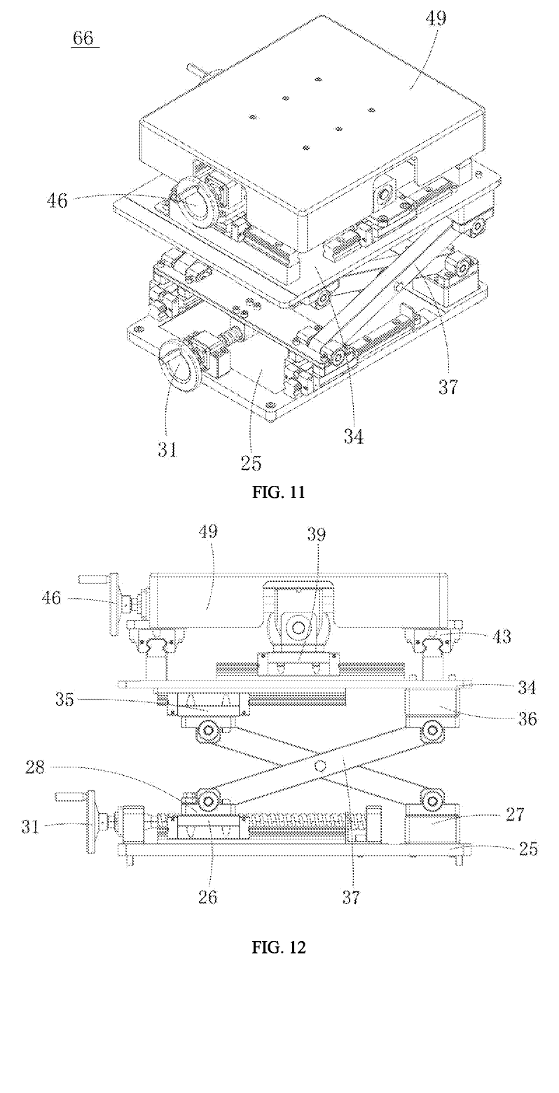

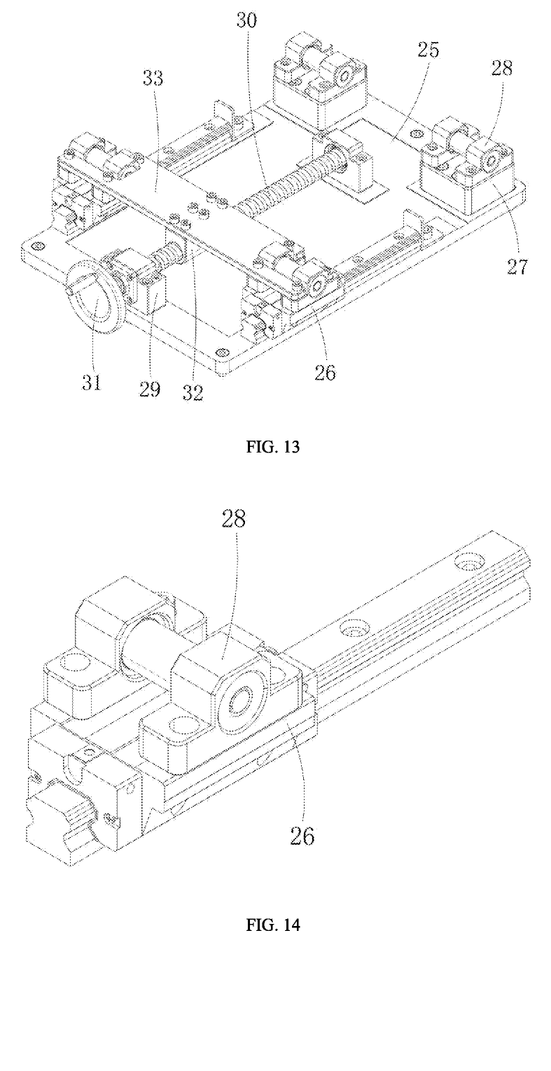

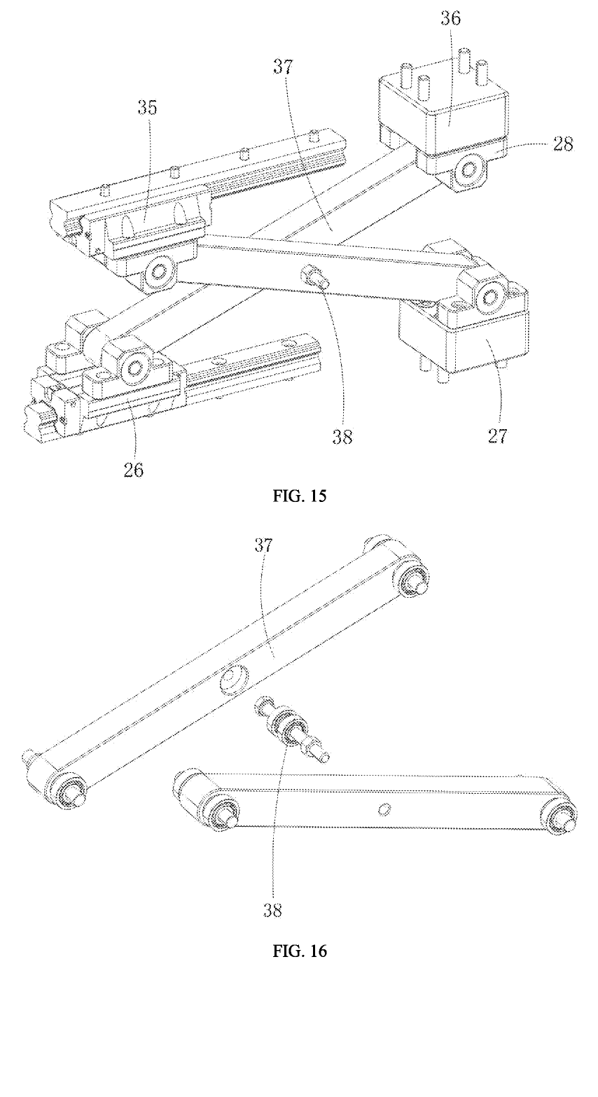

As an implementation in this embodiment, as shown in FIG. 11 to FIG. 18, a second mounting seat 25 is fixedly connected to the top of the base 1, a third mounting seat 49 is installed on a top of the second mounting seat 25, a second adjustment mechanism is installed between the second mounting seat 25 and the third mounting seat 49, the second adjustment mechanism is configured for relative position adjustment between the second mounting seat 25 and the third mounting seat 49, the second adjustment mechanism includes second linear guide rails 26 and first fixing seats 27 symmetrically installed on two sides of the top of the second mounting seat 25, fifth bearing seats 28 are fixedly connected to tops of the second linear guide rails 26 and the first fixing seats 27, a connecting plate 33 is fixedly connected to the fifth bearing seat 28 located on the top of the second linear guide rail 26, a second bearing seat 29 is fixedly connected to the top of the second mounting seat 25, a second driving screw rod 30 is rotatably connected in the second bearing seat 29, a second hand wheel 31 is fixedly connected to one end of the second driving screw rod 30, a second screw rod nut 32 is in threaded connection with an outer wall of the second driving screw rod 30, and a top of the second screw rod nut 32 is fixed with a bottom of the connecting plate 33 through screws.

According to the above structure, a user can rotate the second hand wheel 31 to rotate the second driving screw rod 30 in the second bearing seat 29. During rotation of the second driving screw rod 30, the second screw rod nut 32 moves in a traveling direction of the second linear guide rail 26 under threaded driving action. In this case, two second driving shafts 23 synchronously move under connecting action of the connecting plate 33.

In this embodiment, as shown in FIG. 11 to FIG. 18, the second adjustment mechanism further includes a lifting platform 34 installed on the top of the second mounting seat 25, fifth linear guide rails 35 and second fixing seats 36 are fixedly connected to two sides of a bottom of the lifting platform 34, fifth bearing seats 28 are fixedly connected to bottoms of the fifth linear guide rails 35 and the second fixing seats 36, the fifth linear guide rails 35 and the first fixing seats 27 are fixed through scissor arms 37, the second linear guide rails 26 and the second fixing seats 36 are fixed through scissor arms 37, a total of four scissor arms 37 are provided, every two scissor arms are divided into one group to form two groups, and each group of the scissor arms 37 is rotatably connected together through a rotating shaft 38.

As described above, when a user rotates the second hand wheel 31, the second screw rod nut 32 drives the connecting plate 33 to move in the traveling direction of the second linear guide rail 26. Since the second linear guide rail 26 and the second screw rod nut 32 are fixed through the scissor arms 37, and the fifth linear guide rail 35 and the first fixing seat 27 are fixed through the scissor arms 37, and each group of the scissor arms 37 is rotatably connected together through the rotating shaft 38, when the user rotates the second hand wheel 31, a relative position height between the lifting platform 34 and the second mounting seat 25 can be adjusted by means of a supporting effect of the scissor arms 37. A spacing between the lifting platform 34 and the second mounting seat 25 depends on a number of unidirectional rotation turns of the second hand wheel 31 by the user, and a direction of height adjustment between the lifting platform 34 and the second mounting seat 25 depends on a rotating direction of the second hand wheel 31.

In this embodiment, as shown in FIG. 11 to FIG. 18, the second adjustment mechanism further includes two third linear guide rails 39 and two fourth linear guide rails 43 symmetrically installed on a top of the lifting platform 34, where the two third linear guide rails 39 and the two fourth linear guide rails 43 are oppositely installed on the lifting platform 34, a third bearing seat 40 is fixedly connected to a top of each third linear guide rail 39, a third driving screw rod 41 is rotatably connected in the third bearing seat 40, a third hand wheel 42 is fixedly connected to one end of the third driving screw rod 41, a fourth bearing seat 44 is fixedly connected to a top of each fourth linear guide rail 43, a fourth driving screw rod 45 is rotatably connected in the fourth bearing seat 44, a fourth hand wheel 46 is fixedly connected to one end of the fourth driving screw rod 45, a height of the fourth driving screw rod 45 is greater than a height of the third driving screw rod 41, the fourth driving screw rod 45 is horizontally relatively perpendicular to the third driving screw rod 41, a third screw rod nut 47 is simultaneously in threaded connection with the third driving screw rod 41 and the fourth driving screw rod 45, a second movable platform 48 is fixedly connected to a top of the third screw rod nut 47, and the second movable platform 48 is fixedly connected to a bottom of the third mounting seat 49.

According to the above structure, when a user rotates the third hand wheel 42, the third screw rod nut 47 slides along the third driving screw rod 41 under threaded driving action, and meanwhile the fourth driving screw rod 45 is synchronously driven to slide in a traveling direction of the fourth linear guide rail 43 during sliding of the third screw rod nut 47. When the user rotates the fourth hand wheel 46, the third screw rod nut 47 slides along the fourth driving screw rod 45 under threaded driving action, and meanwhile the third driving screw rod 41 is synchronously driven to slide in a traveling direction of the third linear guide rail 39 during sliding of the third screw rod nut 47. Since the height of the fourth driving screw rod 45 is greater than the height of the third driving screw rod 41, and the fourth driving screw rod 45 is horizontally relatively perpendicular to the third driving screw rod 41, the user can respectively rotate the third hand wheel 42 and the fourth hand wheel 46 to change a position of the second movable platform 48 in two mutually perpendicular directions, and displacements in the two directions do not interfere with each other.

In summary, by arranging the second adjustment mechanism, the user can enable the third mounting seat 49 to use a center of the third mounting seat 49 as a coordinate origin and adjust a position and a height of the third mounting seat 49 in three different directions of X, Y, and Z.

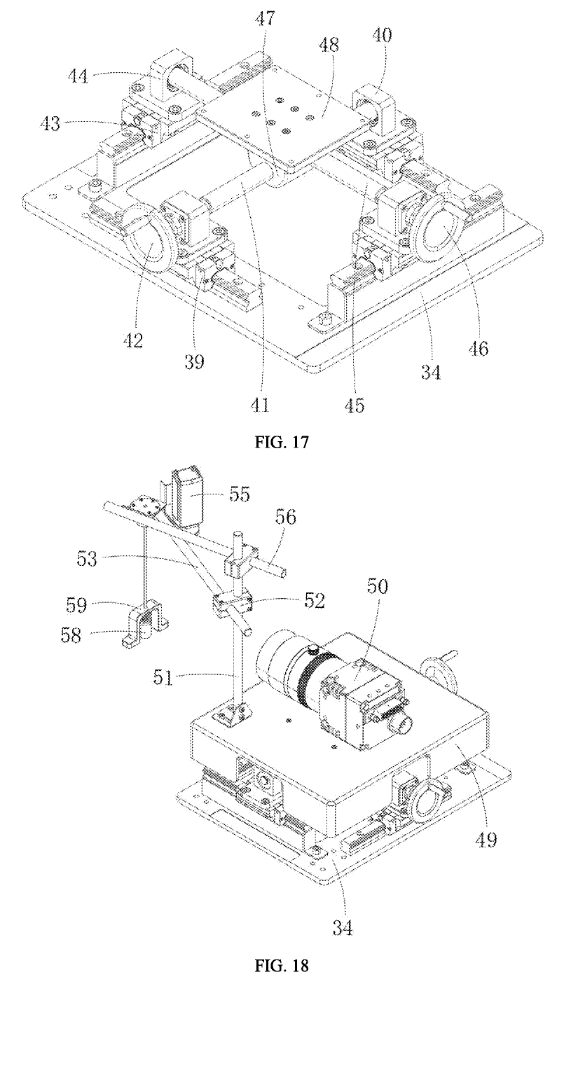

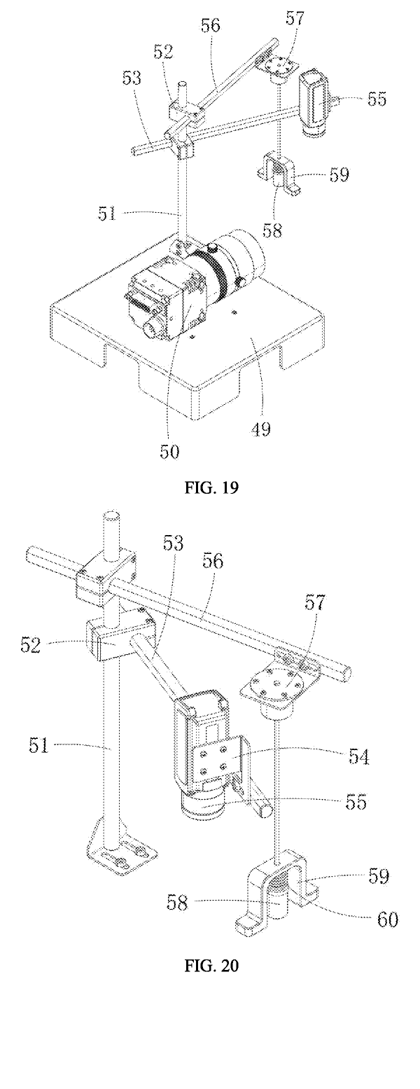

As an implementation in this embodiment, as shown in FIG. 17 to FIG. 20, a high-speed camera 50 is fixedly connected to a middle position of a top of the third mounting seat 49, a support frame 51 is fixedly connected to one side of the top of the third mounting seat 49, an infrared thermal imager 55 and an acoustic emission sensor 58 are installed on the support frame 51, two adjusters 52 are fixedly connected to an outer wall of the support frame 51, a first adjustment rod 53 is inserted on one adjuster 52, a second adjustment rod 56 is inserted on the other adjuster 52, a first mounting frame 54 is fixedly connected to an outer wall of the first adjustment rod 53, the infrared thermal imager 55 and the first adjustment rod 53 are fixed through the first mounting frame 54, a second mounting frame 57 is fixedly connected to an outer wall of the second adjustment rod 56, and the acoustic emission sensor 58 and the second adjustment rod 56 are fixed through the second mounting frame 57.

According to the above structure, the high-speed camera 50 is installed at a center position of the third mounting seat 49, the infrared thermal imager 55 and the acoustic emission sensor 58 are both fixed on the support frame 51 by means of the adjusters 52, and the user can adjust fixing angles and fixing directions of the infrared thermal imager 55 and the acoustic emission sensor 58 by changing fixing angles and fixing directions of the adjusters 52. Meanwhile, the positions and heights of the high-speed camera 50, the infrared thermal imager 55, and the acoustic emission sensor 58 can be uniformly adjusted by means of the second adjustment mechanism.

Further, during use of the instrument, the high-speed camera 50, the infrared thermal imager 55, and the acoustic emission sensor 58 are configured to monitor surface wear, transient arcs, temperature field information, and acoustic signals in real time during the friction between the aluminum alloy disc 12 and the copper alloy disc 24, where a focal point of a lens of the high-speed camera 50 and a side surface at an intersection of the aluminum alloy disc 12 and the copper alloy disc 24 are located on one horizontal line, and the focal point of the lens of the high-speed camera 50 faces contact surfaces of the aluminum alloy disc 12 and the copper alloy disc 24 for photographing friction surfaces of the aluminum alloy disc 12 and the copper alloy disc 24; the infrared thermal imager 55 is arranged directly above the contact surfaces of the aluminum alloy disc 12 and the copper alloy disc 24 and can accurately monitor surface temperature during friction; and the acoustic emission sensor 58 is arranged at a circle center of the copper alloy disc 24, so that vibration and acoustic signals during friction can be directly received while avoiding loss of other media, and the centrifugal force influence during high-speed rotation can also be minimized.

Furthermore, in the second adjustment mechanism, a user can adjust a height of the third mounting seat 49 by rotating the second hand wheel 31, thereby moving a lens of the high-speed camera 50 to a proper position; the user can adjust a position of the third mounting seat 49 by rotating the fourth hand wheel 46, thereby changing a distance between the lens of the high-speed camera 50 and friction surfaces of the aluminum alloy disc 12 and the copper alloy disc 24 to ensure imaging quality of the high-speed camera 50; and the user can change a position of the third mounting seat 49 by rotating the third hand wheel 42, thereby ensuring that, when radii of the aluminum alloy disc 12 and the copper alloy disc 24 are changed, a position of contact surfaces of the aluminum alloy disc 12 and the copper alloy disc 24 can always directly face a focal point of the lens of the high-speed camera 50.

In this embodiment, as shown in FIG. 1, FIG. 2, and FIG. 18 to FIG. 20, the acoustic emission sensor 58 is located at a circle center position of the copper alloy disc 24, a conductive slip ring 59 is sleeved on an outer wall of the acoustic emission sensor 58, the conductive slip ring 59 is fixed with a top outer wall of the copper alloy disc 24 through screws, a second spring 60 is fixedly connected to a bottom of the conductive slip ring 59, a top end of the second spring 60 is attached to the bottom of the conductive slip ring 59, and a bottom end of the second spring 60 is fixed with a top end of the acoustic emission sensor 58.

According to the above structure, the conductive slip ring 59 is rotatably sleeved on an outer side of the acoustic emission sensor 58, and a bottom of the conductive slip ring 59 is fixed with the top of the copper alloy disc 24. When the copper alloy disc 24 rotates, the conductive slip ring 59 synchronously rotates with the copper alloy disc 24. Under elastic force action of the second spring 60, a bottom of the acoustic emission sensor 58 always contacts a surface of the copper alloy disc 24. The signal collection by direct contact between the acoustic emission sensor 58 and the copper alloy disc 24 can reduce signal attenuation and interference. The introduction of the conductive slip ring 59 on the outer side of the acoustic emission sensor 58 can ensure that the acoustic emission sensor 58 does not become wound or knotted during high-speed rotation of the copper alloy disc 24.

Embodiment 2:

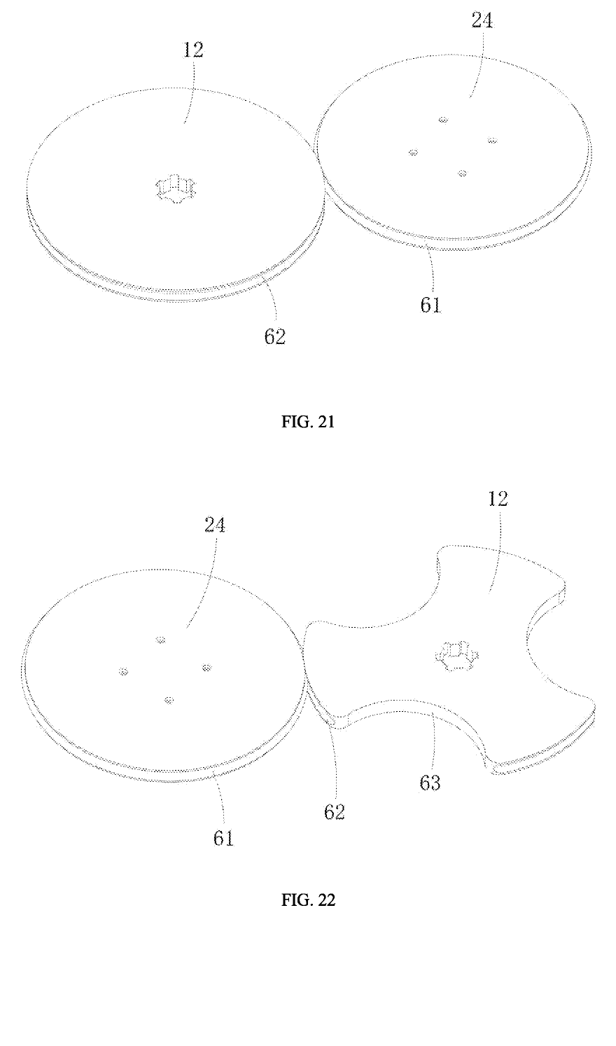

In this embodiment, as shown in FIG. 21 and FIG. 22, a recess 62 is formed in an outer circumference of the aluminum alloy disc 12, a protrusion 61 having a profile consistent with a contour of the recess 62 on the outer circumference of the aluminum alloy disc 12 is fixedly connected to an outer circumference of the copper alloy disc 24, and an intermittent groove 63 is formed in the aluminum alloy disc 12.

According to the above structure, since the contour of the recess 62 on the outer circumference of the aluminum alloy disc 12 is adapted to the contour of the protrusion 61 on the outer circumference of the copper alloy disc 24. Such an arrangement enables outer walls of the aluminum alloy disc 12 and the copper alloy disc 24 to be respectively designed as forms of an outer wall of a shell and an inner wall of a rail, and equivalent shell launching is achieved by relative sliding of disc-shaped samples, thereby improving simulation performance and testing precision of the instrument.

Optionally, since the aluminum alloy disc 12 and the copper alloy disc 24 are both detachable disc body structures, a user can replace aluminum alloy discs 12 having different shapes, thereby achieving an effect of intermittent friction of products. Specifically, by forming the intermittent groove 63 in the aluminum alloy disc 12, a friction interval exists at a formed position of the intermittent groove 63 during mutual rotational friction between the aluminum alloy disc 12 and the copper alloy disc 24, thereby achieving an effect of intermittent friction between the aluminum alloy disc 12 and the copper alloy disc 24.

A working principle of the technical solution provided by the present application is as follows:

During use, a user first respectively installs the aluminum alloy disc 12 and the copper alloy disc 24 on tops of the first driving shaft 10 and the second driving shaft 23, then adjusts relative positions between the aluminum alloy disc 12 and the copper alloy disc 24 by rotating the first hand wheel 6, so that the aluminum alloy disc 12 and the copper alloy disc 24 contact each other, then installs and fixes the high-speed camera 50 at a center position of the third mounting seat 49, and installs and fixes the infrared thermal imager 55 and the acoustic emission sensor 58 on the support frame 51. During the installation of the high-speed camera 50, the user can adjust a height of the third mounting seat 49 by rotating the second hand wheel 31, thereby moving a lens of the high-speed camera 50 to a proper position; the user can adjust a position of the third mounting seat 49 by rotating the fourth hand wheel 46, thereby changing a distance between the lens of the high-speed camera 50 and friction surfaces of the aluminum alloy disc 12 and the copper alloy disc 24 to ensure imaging quality of the high-speed camera 50; and the user can change a position of the third mounting seat 49 by rotating the third hand wheel 42, thereby ensuring that, when radii of the aluminum alloy disc 12 and the copper alloy disc 24 are changed, a position of contact surfaces of the aluminum alloy disc 12 and the copper alloy disc 24 can always directly face a focal point of the lens of the high-speed camera 50. During the installation of the infrared thermal imager 55 and the acoustic emission sensor 58, the user can adjust fixing angles and fixing directions of the infrared thermal imager 55 and the acoustic emission sensor 58 by changing fixing angles and fixing directions of the adjusters 52 on the support frame 51, so that the infrared thermal imager 55 is arranged directly above the contact surfaces of the aluminum alloy disc 12 and the copper alloy disc 24 and can accurately monitor surface temperature during friction; and the acoustic emission sensor 58 is arranged at a circle center of the copper alloy disc 24, so that vibration and acoustic signals during friction can be directly received while avoiding loss of other media, and the centrifugal force influence during high-speed rotation can also be minimized. After installation of the acoustic emission sensor 58 is completed, the conductive slip ring 59 is fixed on the top of the copper alloy disc 24.

After the above operations are completed, the user starts the first motor 9 and the second motor 20 to respectively drive the aluminum alloy disc 12 and the copper alloy disc 24 to rotate. The friction between the aluminum alloy disc 12 and the copper alloy disc 24 is configured to simulate current-carrying friction between an armature and a rail during shell launching. During a test process, when current needs to be loaded to the aluminum alloy disc 12 and the copper alloy disc 24, the user first pulls the brush rod 17 downward, then inserts an electric wire into a small hole at a connection position of the handle 16 and the brush rod 17, and finally clamps the electric wire by screwing the handle 16 under threaded cooperation action, while a bottom of the handle 16 presses the brush rod 17, so that a bottom of the brush rod 17 contacts upper surfaces of the aluminum alloy disc 12 and the copper alloy disc 24. When the electric wire is energized, current can be loaded to the aluminum alloy disc 12 and the copper alloy disc 24 by means of the brush rod 17. A magnitude of current on the surfaces of the aluminum alloy disc 12 and the copper alloy disc 24 depends on an energizing magnitude of the electric wire. Direct-current voltage is loaded to the surfaces of the aluminum alloy disc 12 and the copper alloy disc 24 by means of the brush rod 17, so that current during sample friction is generated on the surfaces of the aluminum alloy disc 12 and the copper alloy disc 24. A supply voltage of the electric wire may be loaded by a fully charged large-capacity capacitor to simulate one-time shell launching, similar to a miniature electromagnetic rail launch process. The electric wire may also be powered by a high-voltage constant-current source to continuously and uninterruptedly simulate a high-speed high-current current-carrying friction process. During the test process, the high-speed camera 50, the infrared thermal imager 55, and the acoustic emission sensor 58 are configured to monitor surface wear, transient arcs, temperature field information, and acoustic signals during friction in real time.

The present application covers any substitution, modification, equivalent method, and solution made within the spirit and scope of the present application. To provide the public with a thorough understanding of the present application, specific details are described in detail in the following preferred embodiments of the present application. However, those skilled in the art can fully understand the present application without descriptions of such details. In addition, to avoid unnecessary obscuring of the substance of the present application, well-known methods, processes, procedures, elements, circuits, and the like are not described in detail.

The above descriptions are only preferred implementations of the present application. It should be noted that, for those of ordinary skill in the art, several improvements and modifications may further be made without departing from principles of the present application, and such improvements and modifications shall also fall within the protection scope of the present application.

What is claimed is:

1. An intermittent in-situ current-carrying friction testing device, comprising: a base, wherein a first mounting seat is fixedly connected to a top of the base, a first movable platform is slidably connected to a top of the first mounting seat, a first adjustment mechanism is installed between the first mounting seat and the first movable platform, and the first adjustment mechanism is configured for relative position adjustment between the first mounting seat and the first movable platform;
a double-disc friction mechanism is installed on the top of the base, and the double-disc friction mechanism is connected to each of the first movable platform and the base;
a second mounting seat is fixedly connected to the top of the base, a third mounting seat is installed on a top of the second mounting seat, a second adjustment mechanism is installed between the second mounting seat and the third mounting seat, and the second adjustment mechanism is configured for relative position adjustment between the second mounting seat and the third mounting seat;
a high-speed camera is fixedly connected to a middle position of a top of the third mounting seat, a support frame is fixedly connected to one side of the top of the third mounting seat, and an infrared thermal imager and an acoustic emission sensor are installed on the support frame;
the double-disc friction mechanism comprises a first motor and a first machine cover fixedly connected to the top of the first movable platform, a first driving shaft is rotatably connected in the first machine cover, and an aluminum alloy disc is fixedly connected to a top end of the first driving shaft;
the double-disc friction mechanism further comprises a second machine cover and a second motor fixedly connected to the top of the base, a second driving shaft is rotatably connected in the second machine cover, and a copper alloy disc is fixedly connected to a top end of the second driving shaft; and
a recess is formed in an outer circumference of the aluminum alloy disc, a protrusion having a profile consistent with a contour of the recess on the outer circumference of the aluminum alloy disc is fixedly connected to an outer circumference of the copper alloy disc, and an intermittent groove is formed in the aluminum alloy disc.

2. The intermittent in-situ current-carrying friction testing device according to claim 1, wherein the first adjustment mechanism comprises first linear guide rails symmetrically installed on two sides of the top of the first mounting seat, a first bearing seat is fixedly connected to a middle position of the top of the first mounting seat, a first driving screw rod is rotatably connected in the first bearing seat, a first hand wheel is fixedly connected to one end of the first driving screw rod, and a first screw rod nut is in threaded connection with an outer wall of the first driving screw rod.

3. The intermittent in-situ current-carrying friction testing device according to claim 1, wherein a first bevel gear set is installed in the first machine cover, and a driving gear set and a second bevel gear set are installed in the second machine cover.

4. The intermittent in-situ current-carrying friction testing device according to claim 1, wherein a U-shaped frame is fixedly connected to the top of the first movable platform, brush cylinders are fixedly connected to the U-shaped frame and a top of the second machine cover, a handle and a brush rod are sequentially inserted on each brush cylinder from top to bottom, a bottom end of the handle is attached to a top end of the brush rod, a first spring is fixedly connected in the brush cylinder, one end of the first spring is fixed with the top end of the brush rod, and the other end of the first spring is fixed with an inner wall of the brush cylinder.

5. The intermittent in-situ current-carrying friction testing device according to claim 1, wherein two adjusters are fixedly connected to an outer wall of the support frame, a first adjustment rod is inserted on one adjuster, a second adjustment rod is inserted on the other adjuster, a first mounting frame is fixedly connected to an outer wall of the first adjustment rod, the infrared thermal imager and the first adjustment rod are fixed through the first mounting frame, a second mounting frame is fixedly connected to an outer wall of the second adjustment rod, and the acoustic emission sensor and the second adjustment rod are fixed through the second mounting frame; and
the acoustic emission sensor is located at a circle center position of the copper alloy disc, a conductive slip ring is sleeved on an outer wall of the acoustic emission sensor, a second spring is fixedly connected to a bottom of the conductive slip ring, a top end of the second spring is attached to the bottom of the conductive slip ring, and a bottom end of the second spring is fixed with a top end of the acoustic emission sensor.

6. The intermittent in-situ current-carrying friction testing device according to claim 1, wherein the second adjustment mechanism comprises second linear guide rails and first fixing seats symmetrically installed on two sides of the top of the second mounting seat, fifth bearing seats are fixedly connected to tops of the second linear guide rails and the first fixing seats, and a connecting plate is fixedly connected to the fifth bearing seat located on the top of the second linear guide rail; and
a second bearing seat is fixedly connected to the top of the second mounting seat, a second driving screw rod is rotatably connected in the second bearing seat, a second hand wheel is fixedly connected to one end of the second driving screw rod, and a second screw rod nut is in threaded connection with an outer wall of the second driving screw rod.

7. The intermittent in-situ current-carrying friction testing device according to claim 6, wherein the second adjustment mechanism further comprises a lifting platform installed on the top of the second mounting seat, fifth linear guide rails and second fixing seats are fixedly connected to two sides of a bottom of the lifting platform, the fifth bearing seats are fixedly connected to bottoms of the fifth linear guide rails and the second fixing seats, the fifth linear guide rails and the first fixing seats are fixed through scissor arms, the second linear guide rails and the second fixing seats are fixed through scissor arms, a total of four scissor arms are provided, every two scissor arms are divided into one group to form two groups, and each group of the scissor arms is rotatably connected together through a rotating shaft.

8. The intermittent in-situ current-carrying friction testing device according to claim 7, wherein the second adjustment mechanism further comprises two third linear guide rails and two fourth linear guide rails symmetrically installed on the top of the lifting platform, and the two third linear guide rails and the two fourth linear guide rails are oppositely installed on the lifting platform;
a third bearing seat is fixedly connected to a top of the third linear guide rail, a third driving screw rod is rotatably connected in the third bearing seat, and a third hand wheel is fixedly connected to one end of the third driving screw rod;
a fourth bearing seat is fixedly connected to a top of the fourth linear guide rail, a fourth driving screw rod is rotatably connected in the fourth bearing seat, and a fourth hand wheel is fixedly connected to one end of the fourth driving screw rod; and
a height of the fourth driving screw rod is greater than a height of the third driving screw rod, the fourth driving screw rod is horizontally relatively perpendicular to the third driving screw rod, a third screw rod nut is simultaneously in threaded connection with the third driving screw rod and the fourth driving screw rod, a second movable platform is fixedly connected to a top of the third screw rod nut, and the second movable platform is fixedly connected to a bottom of the third mounting seat.
